(19) United States
(12) Patent Application Publication
(10) Pub. No.: US 2013/0241851 A1
(43) Pub. Date: Sep. 19, 2013

(54) ELECTRODE UNIT WITH PERIMETER-LENGTHENED TOUCH-SENSING PATTERN FOR TOUCH-SENSING ELEMENT LOCATED AT FRINGES OF TOUCH PANEL

(71) Applicant: RAYDIUM SEMICONDUCTOR CORPORATION, Hsinchu (TW)

(72) Inventors: Sheng-Fu Wang, Tainan City (TW); Kun-Pei Lee, Miaoli County (TW)

(73) Assignee: RAYDIUM SEMICONDUCTOR CORPORATION, Hsinchu (TW)

(21) Appl. No.: 13/746,286

(22) Filed: Jan. 21, 2013

(30) Foreign Application Priority Data
Mar. 13, 2012 (TW) 101108420

(51) Int. Cl. G06F 3/041

(52) U.S. Cl. CPC G06F 3/041
USPC 345/173

(57) ABSTRACT

An electrode unit on a touch-sensing element includes a first electrode, a second electrode, and a plurality of fifth conductive elements. The first electrode includes a first conductive element and a plurality of second conductive elements. The first conductive element has a plurality of first funnel-shaped notches. The plurality of second conductive elements extends from the first conductive element. The second electrode includes a third conductive element and a plurality of fourth conductive elements. The third conductive element has a plurality of second funnel-shaped notches. The plurality of fourth conductive elements extends from the third conductive element. The plurality of fifth conductive elements extends from the third conductive element.

### BACKGROUND OF THE INVENTION

1. Field of the Invention

The disclosed embodiments of the present invention relate to a sensing pattern design, and more particularly, to an electrode unit with a perimeter-lengthened touch-sensing pattern on a touch-sensing element located at fringes of a touch panel.

2. Description of the Prior Art

Regarding a single-layered capacitive touch panel, a touch-sensing element on a touch panel is usually implemented using longitudinal electrodes and transverse electrodes with transparent conductive materials (e.g., indium tin oxide (ITO)). When a finger touches a longitudinal electrode and a transverse electrode, an inductive capacitance between the touched longitudinal electrode and transverse electrode alters responsively. The difference of the inductive capacitance before and after the touch can then be used to calculate where the contact is.

Please refer to FIG. 1, which is a schematic diagram illustrating an example of a sensing pattern of electrodes on a conventional touch panel TP. The touch panel TP includes a plurality of touch-sensing elements TU, where each of the touch-sensing elements TU has an electrode unit 100 thereon, and the electrode unit 100 includes at least a first transverse electrode 110 and a second longitudinal electrode 120. As shown in FIG. 1, the touch-sensing elements TU are staggered as a rectangular pattern, and the first electrode 110 on the same row are series-connected as a sensing trace, and the second electrode 120 on the same column are series-connected as a sensing trace. In this way, the touch panel TP would have a plurality of transverse sensing traces T1-TN and a plurality of longitudinal sensing traces S1-SM. In addition, the electrode unit 100 also has a separation unit constituted by insulation material and disposed on an intersection of the corresponding first electrode 110 and second electrode 120. Hence, the sensing traces T1-TN and sensing traces S1-SM would not be electrically connected.

However, since an area being able to induct the inductive capacitance between two adjacent electrodes (i.e., the first electrode 110 and the second electrode 120) on the touch-sensing element TU located on fringes of the touch panel TP is smaller than an area being able to induct the inductive capacitance between two adjacent electrodes (i.e., the first electrode 110 and the second electrode 120) on the touch-sensing element TU located in the middle of the touch panel TP, when the finger enters the touch panel TP from the fringe, the inductive capacitance sensed by the electrodes on the fringes is smaller than inductive capacitance sensed by the electrodes in an effective sensing area, which is prone to misjudgment.

Therefore, there is a need to enhance the inductive capacitance sensed by the electrodes of the touch-sensing element located on the fringes of the touch panel, in order to decrease the likelihood of faulty calculation of contact on the fringes of the touch panel.

### SUMMARY OF THE INVENTION

In accordance with exemplary embodiments of the present invention, an electrode unit with a perimeter-lengthened touch-sensing pattern on a touch-sensing element located at fringes of a touch panel is proposed to solve the above-mentioned problem.

According to an aspect of the present invention, an exemplary electrode unit is disclosed. The electrode unit includes a first electrode, a second electrode, and a plurality of fifth conductive elements. The first electrode includes a first conductive element and a plurality of second conductive elements. The first conductive element has a plurality of first funnel-shaped notches. The plurality of second conductive elements extends from the first conductive element. The second electrode includes a third conductive element and a plurality of fourth conductive elements. The third conductive element has a plurality of second funnel-shaped notches. The plurality of fourth conductive elements extends from the third conductive element. The plurality of fifth conductive elements extends from the third conductive element.

Therefore, when deployed on the touch-sensing element located on the fringes of the touch panel, the present invention can decrease the likelihood of faulty calculation of contact on the fringes of the touch panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an example of a sensing pattern of electrodes on a conventional touch panel.

FIG. 2A is a top view illustrating an electrode unit on a touch-sensing element according to an embodiment of the present invention.

FIG. 2B is a schematic diagram illustrating an embodiment of the first electrode in FIG. 2A.

FIG. 2C is a schematic diagram illustrating an embodiment of the second electrode in FIG. 2A.

FIG. 3 is a schematic diagram illustrating a sensing pattern of electrode units shown in FIG. 2A on a touch panel according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

When an object touches an electrode unit of a current touch-sensing element and an electrode unit on an adjacent touch-sensing element, a contact of the object can be determined by calculating the difference between an inductive capacitance C sensed by the electrode unit before and after the touch, and comparing the inductive capacitance C with an inductive capacitance C′ sensed by the electrode unit on the adjacent touch-sensing element. Therefore, a concept of the present invention is to increase the inductive capacitance C sensed by a touch-sensing element located on a fringe of a touch panel by increasing contact areas being able to induct the inductive capacitance C on an electrode unit of the touch-sensing element, such that accuracy of determining the contact of the object can be improved. More specifically, since an electrode itself has a certain thickness, the present invention may increase the contact areas being able to induct the inductive capacitance C by increasing a perimeter of a sensing pattern formed by the electrode unit.

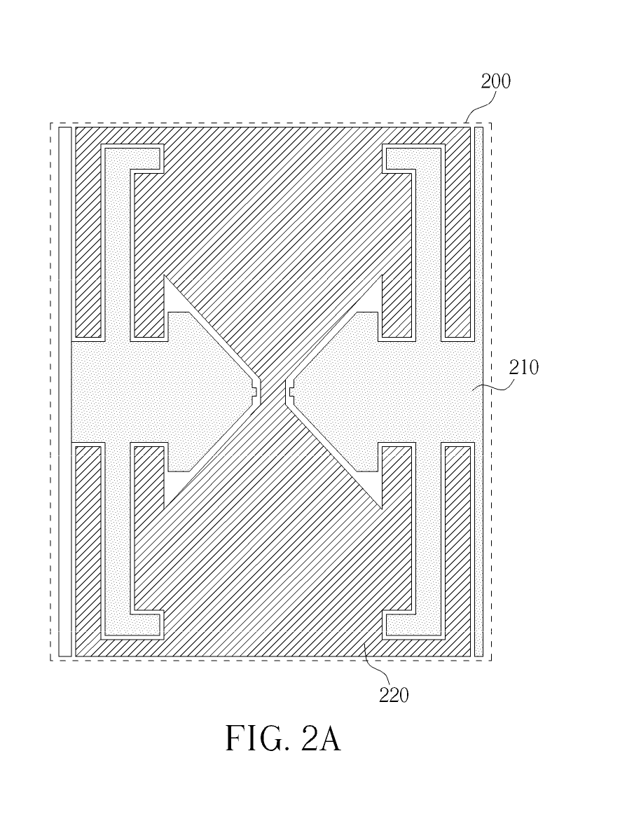

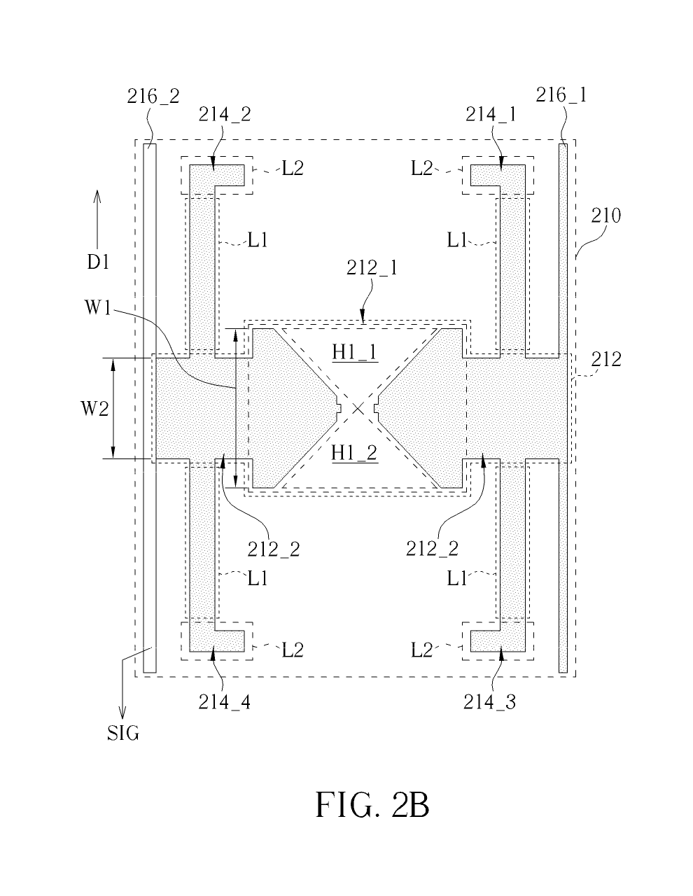

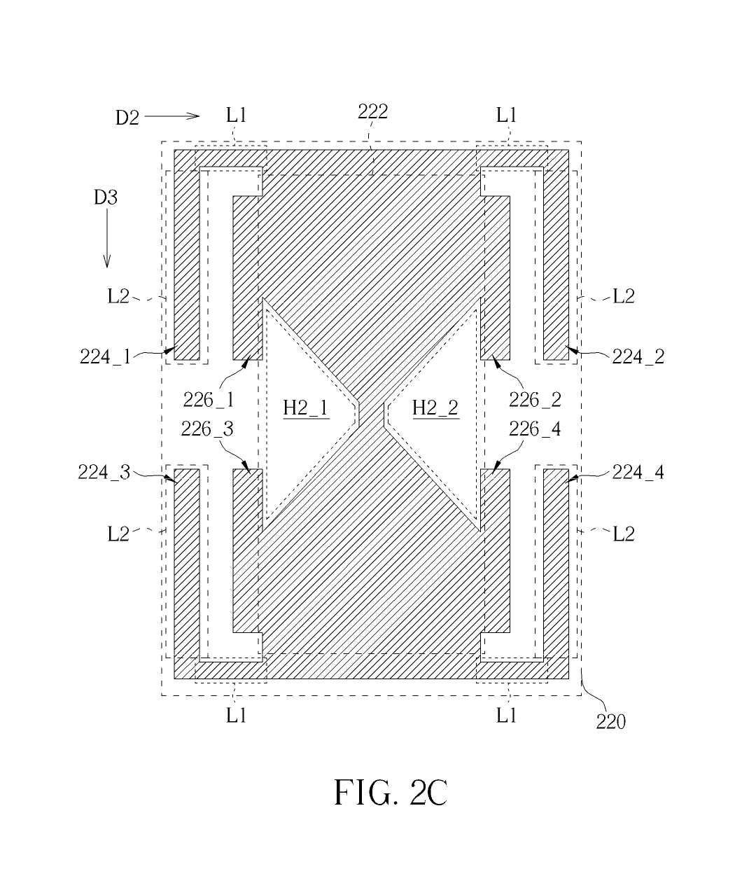

Please refer to FIG. 2A, which is a top view illustrating an electrode unit 200 on a touch-sensing element TU′ according to an embodiment of the present invention. In FIG. 2A, the electrode unit 200 includes a first electrode 210 and a second electrode 220. In addition, the electrode unit 200 also has a separation unit (not shown in FIG. 2A) constituted by insulation material and disposed at an intersection of the first electrode 210 and the second electrode 220 and located in between the first electrode 210 and the second electrode 220, such that the first electrode 210 and the second electrode 220 are not electrically connected. Therefore, there may be an inductive capacitance inducted between the first electrode 210 and the second electrode 220.

Please refer to FIG. 2A and FIG. 2B concurrently. FIG. 2B is a schematic diagram illustrating an embodiment of the first electrode 210 shown in FIG. 2A. The first electrode 210 includes a first conductive element 212 and a plurality of second conductive element 214_1-214_4. In this embodiment, the first conductive element 212 includes a wider part 212_1 and a narrower part 21 2_2, where the wider part 212_1 is located at a middle section of the first conductive element 212, and a width W1 of the wider part 212_1 is greater than a width W2 of the narrower part 212_2 (i.e., W1>W2). The first conductive element 212 has a plurality of first funnel-shaped notches H1_1 and H1 _2 located on both sides of the wider part 212_1, respectively. In addition, each of the second conductive elements 214_1-214_4 is strip-shaped, and includes at least a first section L1 and a second section L2. The first section L1 extends outward from the first conductive element 212 in directions in parallel with a first direction D1, and the second section L2 is not in parallel with the first section L1. In other words, a joint of the first section L1 and its corresponding second section L2 of each of the second conductive elements 214_1-214_4 forms a bent part.

Please note that, in this embodiment, the first section L1 and its corresponding second section L2 of each of the second conductive elements 214_1-214_4 are perpendicular to each other, and each of the second conductive elements 214_1 -214_4 has only one bent part. However, it is for illustrative purpose only, and is not meant for a limitation of the present invention. For example, in another embodiment, at least one conductive element in the second conductive elements 214_1-214_4 may include a first section, a second section and a third section, where the first section is not in parallel with the second section, and the second section is not in parallel with the third section. At this moment, the conductive element that includes the first section, the second section and third section has two bent parts. That is, each of the conductive elements in the second conductive elements 214_1-214_4 has at least one bent part, and different conductive elements may have different numbers of bent parts. Besides, this embodiment uses 4 second conductive elements for illustrative purpose only, and it is not meant for a limitation of the present invention. Those skilled in the art should readily increase/decrease the number of second conductive elements according to actual design requirement.

In addition, the electrode unit 200 further includes a plurality of third conductive elements 216_1 and 216_2 straightly extending outward from two ends of the first conductive element 212 in directions in parallel with the first direction D1, respectively, so as to output a sensing signal SIG sensed by the first electrode 210. The third conductive elements 216_1 and 216_2 are substantially strip-shaped, respectively. That is, the third conductive elements 216_1 and 216_2 may be considered as conductive wires, respectively, for outputting the sensing signal SIG. Please note that, in this embodiment, the first conductive element 212 and the second conductive elements 214_1-214_4 may be realized by indium tin oxide (ITO), and the third conductive elements 216_1 and 216_2 may also be realized by ITO, or realized by conductive metal (i.e., implemented in a metal layer of the touch-sensing element) based on actual requirement of signal output layouts. However, it is for illustrative purpose only, and is not meant for a limitation of the present invention.

Please refer to FIG. 2A and FIG. 2C concurrently. FIG. 2C is a schematic diagram illustrating an embodiment of the second electrode 220 shown in FIG. 2A. The second electrode 220 includes a fourth conductive element 222, a plurality of fifth conductive elements 224_1-224_4 and a plurality of sixth conductive elements 226_1 -226_4. The fourth conductive element 222 has a plurality of second funnel-shaped notches H2_1 and H2_2 located at both sides of the fourth conductive element 222, respectively, and the fourth conductive element 222 together with the notches H2_1 and H2_2 may substantially form a rectangle. Each of the fifth conductive elements 224_1-224_4 is strip-shaped, and includes a first section L1 and a second section L2. The first section L1 extends outward from the fourth conductive element 222 in directions in parallel with a second direction D2, and the second section L2 is not in parallel with the first section L1. In other words, a joint of the first section L1 and its corresponding second section L2 of each of fifth conductive elements 224_1 -224_4 forms a bent part. In addition, each of sixth conductive elements 226_1 -226_4 is strip-shaped, straightly extending outward from the fourth conductive element 222 in directions in parallel with a third direction D3, and the third direction D3 is different from the second direction D2 (in this embodiment, the second direction D2 is perpendicular to the third direction D3, but it is for illustrative purpose only). However, when the touch-sensing element TU′ is located at one of the corners of the touch panel (e.g. an upper-left corner, an upper-right corner, a lower-left corner or a lower-right corner), the sixth conductive elements 226_1-226_4 would straightly extend outward in directions in parallel with the second direction D2.

Please note that, in this embodiment, the first section L1 and its corresponding second section L2 of each of fifth conductive elements 224_1-224_4 are perpendicular to each other, and each of the fifth conductive elements 224_1 -224_4 has only one bent part. However, it is for illustrative purpose only, and is not meant for a limitation of the present invention. For example, in another embodiment, at least one conductive element in the fifth conductive elements 224_1 -224_4 may include a first section, a second section and a third section, where the first section is not in parallel with the second section, and the second section is not in parallel with the third section. At this moment, the conductive element that includes the first section, the second section and third section has two bent parts. That is, each of the conductive elements in the fifth conductive elements 224_1-224_4 has at least one bent part, and different conductive elements may have different numbers of bent parts. Please note that, in this embodiment, the fourth conductive element 222, the fifth conductive elements 224_1-224_4 and the sixth conductive element 226_1-226_4 may be realized by ITO. In addition, this embodiment uses 4 fifth conductive elements and 4 sixth conductive elements for illustrative purpose only, and it is not meant for a limitation of the present invention. Those skilled in the art should readily increase/decrease the number of fifth conductive elements and the number of sixth conductive elements according to actual design requirement.

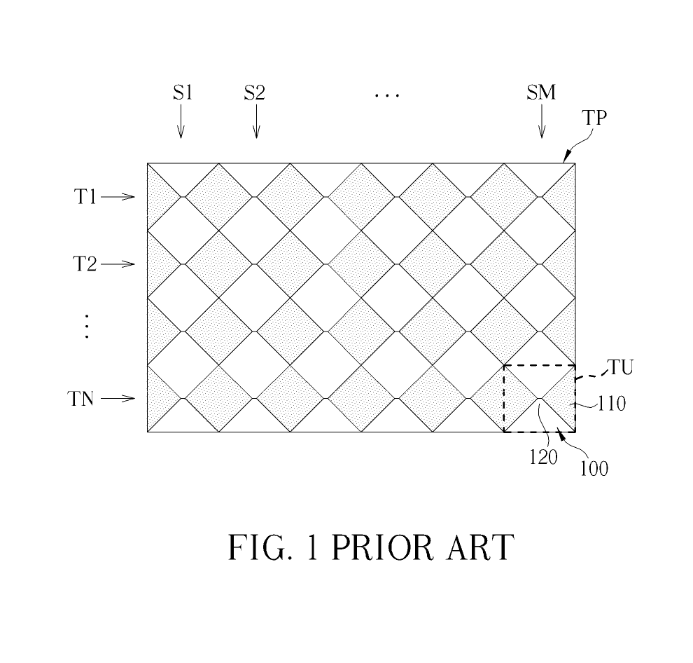

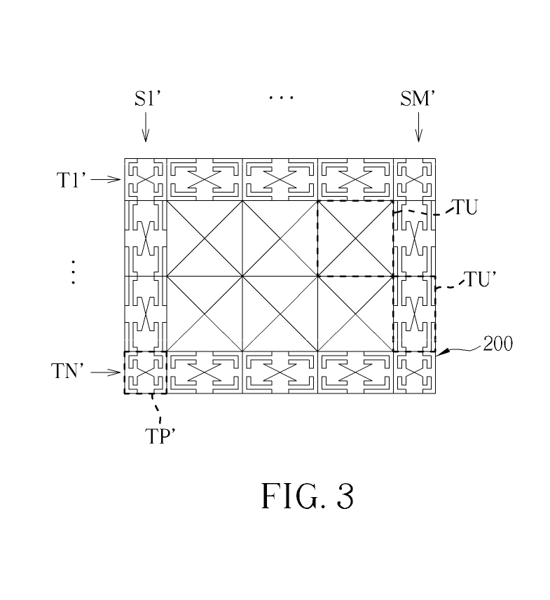

Please refer to FIG. 3, which is a schematic diagram illustrating a sensing pattern of electrode units 200 on a touch panel TP′ according to an embodiment of the present invention. In this embodiment, the touch panel TP′ includes a plurality of touch-sensing elements TU shown in FIG. 1 that are orderly arranged in the middle of the touch panel TP′, and further includes a plurality of touch-sensing elements TU′ shown in FIG. 2 that are accordingly arranged at fringes of the touch panel TP. In other words, electrode units in the touch-sensing element TU′ are fringe electrodes. As shown in FIG. 3, the touch-sensing elements TU are staggered in order to thereby form a rectangular pattern, first electrodes 110 on the same row are series-connected as a sensing trace, and second electrodes 120 on the same column are series-connected as a sensing trace. In addition, two ends of each sensing trace formed by series-connected first electrodes 110 are coupled to the corresponding electrode units 210 on the touch-sensing element TU′, and two ends of each sensing trace formed by series-connected second electrodes 120 are coupled to the corresponding electrode units 220 on the touch-sensing element TU′. In this way, the touch panel TP′ would have a plurality of transverse sensing traces T1′-TN′ and a plurality of longitudinal sensing traces S1′-SM′. Those skilled in the art should readily understand operations of the touch panel TP′ in FIG. 3 after reading the above mentioned paragraph directed to the electrode unit 200. Hence, detailed descriptions and modifications may be referred to the above and therefore omitted here for brevity.

To sum up, according to the present invention, the electrode unit 200 may increase contact areas arranged for inducting the inductive capacitance C by increasing the perimeter of the sensing pattern formed by the first electrode 210 and the second electrode 220, so as to increase the value of the inductive capacitance C sensed by the touch-sensing element located on the fringes of the touch panel, and thus may decrease the likelihood of faulty calculation of contact on the fringes of the touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrode unit on a touch-sensing element, comprising:
a first electrode, comprising:
a first conductive element, having a plurality of first funnel-shaped notches; and
a plurality of second conductive elements, extending from the first conductive element; and
a second electrode, comprising:
a third conductive element, having a plurality of second funnel-shaped notches;
a plurality of fourth conductive elements, extending from the third conductive element; and
a plurality of fifth conductive elements, extending from the third conductive element.

2. The electrode unit of claim 1, wherein the first electrode and the second electrode are not electrically connected.

3. The electrode unit of claim 1, wherein the first conductive element includes a wider part and a narrower part, and a width of the wider part is greater than a width of the narrower part.

4. The electrode unit of claim 3, wherein the plurality of first funnel-shaped notches are located in the wider part.

5. The electrode unit of claim 1, wherein the plurality of second conductive elements are strip-shaped, each of the plurality of second conductive elements includes a the first section and a the second section, the first section extends in directions in parallel with a first direction, and the second section is not in parallel with the first section.

6. The electrode unit of claim 5, further comprising:
a plurality of sixth conductive elements, straightly extending from the first conductive element in a direction in parallel with the first direction, for outputting a sensing signal sensed by the first electrode.

7. The electrode unit of claim 1, wherein the third conductive element is a rectangle having the plurality of second funnel-shaped notches.

8. The electrode unit of claim 1, wherein the plurality of fourth conductive elements are strip-shaped, each of the plurality of fourth conductive elements includes a the first section and a the second section, the first section extends in directions in parallel with a first direction, and the second section in not in parallel with the first section.

9. The electrode unit of claim 8, wherein the plurality of fifth conductive elements are strip-shaped and straightly extend from the third conductive element in directions in parallel with the first direction.

10. The electrode unit of claim 8, wherein the plurality of fifth conductive elements are strip-shaped and straightly extend from the third conductive element in directions in parallel with a second direction, and the second direction is different from the first direction.

11. The electrode unit of claim 1, wherein the electrode unit is a fringe electrode.
